(19) United States
(12) Patent Application Publication
(10) Pub. No.: US 2026/0169232 A1
(43) Pub. Date: Jun. 18, 2026

(54) MULTI-FIBER PUSH ON (MPO) CONNECTOR MANIPULATION DEVICE AND METHODS OF USE

(71) Applicant: Mellanox Technologies, Ltd., Yokneam (IL)

(72) Inventors: Sagi PORAT, Haifa (IL); Nimer HAZIN, Ba'ne (IL); Alon ROKACH, Haifa (IL); Andrey GER, Shlomi (IL)

(21) Appl. No.: 18/985,976

(22) Filed: Dec. 18, 2024

(51) Int. Cl. G02B 6/38

(52) U.S. Cl. CPC G02B 6/3833; G02B 6/3885; G02B 6/3893

(57) ABSTRACT

A device for manipulating multi-fiber push on (MPO) connectors is provided. The device includes a jacket guide that extends from a first end to a second end along a primary axis. The jacket guide comprises a channel configured for accommodating at least a portion of a cable therein. The device further includes a latch portion disposed at the first end of the jacket guide and configured to engage an MPO connector.

### BACKGROUND

Datacenters rely on a fast and robust communication infrastructure. This is achieved by using optical cables to physically link various components, including different server racks. The optical cables are generally connected to the transceivers or other components in the rack using multi-fiber push on (MPO) connectors.

### GENERAL DESCRIPTION

Various embodiments provide an MPO manipulation device configured for manipulation of MPO connectors. Various embodiments provide methods for use of an MPO manipulation device. Due to the large number of connections into and out of a rack, there may be a high spatial density of MPO connectors in the rack. It may be difficult to remove a selected MPO connector in such environments, especially without disrupting the connections of neighboring MPO connectors. As described above, datacenters, networking environments, and other communication systems may include connections between switch systems, servers, racks, and other devices in order to provide for signal transmission between one or more of these elements. Such connections may be made using cables, transceivers, networking boxes, modules, printed circuit boards (PCBs), and connector assemblies, each of which may have a different size, shape, form factor, or the like as defined by applicable regulations or standards. For example, optical communications systems may employ various networking cables, modules, connectors, and the like to enable data flow between system components that are governed by applicable regulations or standards. By way of a particular example, InfiniBand® and Ethernet are standards used in high-performance computing that regulate networking connections having high bandwidth, for example 400 Gbit/s. The InfiniBand® standard is often relevant for communications links between processors and I/O devices, and the Ethernet standard is often relevant for communication links in local area networks (LAN), metropolitan area networks (MAN), and wide area networks (WAN).

To provide connection between devices in either standard, MT (Mechanical Transfer) connectors and associated MT ferrules may be used. These MT connectors May include alignment mechanisms defining, for example, two (2) stainless steel guide pins that fit into precisely molded alignment holes. Such an MT connector may also be used as a fiber interface for Multi-fiber Push On (MPO) connectors. These MPO connectors may include multiple optical fibers, such as eight (8), twelve (12), and twenty-four (24) fiber configurations for datacenter applications or high-density multi-fiber arrays with MPOs of as many as seventy-two (72) fibers for large scale optical switch applications. Each of these MPO connectors may be subject to intermateability standards that specify the physical attributes of the connector, such as pin and guide hole dimensions for male and female interfaces, so as to ensure that any compliant transceivers, modules, and/or adapters may be intermated. MT ferrules refer to an optical standard that is designed within the MPO housing; however, other housing options are currently available for MT ferrules.

With regard to the high-performance computing standards described above, the InfiniBand® standard requires two (2) MT12 ferrules that each include four (4) channels where each channel includes two (2) fibers such that only eight (8) fibers of the available twelve (12) are used. In contrast, the Ethernet standard requires an MT16 ferrule that includes eight (8) channels where each channel includes two (2) fibers such that sixteen (16) channels are used. As such, traditional systems fail to provide devices that are operable with both the InfiniBand® standard and the Ethernet standard. By way of example, traditional systems often require separate, distinct housing or backshell designs that are only compliant with one of these standards resulting in costly manufacturing and cumbersome installation. Furthermore, these standard-specific backshell designs may require direct connections or interfacing with transceiver components. In applications in which sufficient clearance in not easily provided, these conventional components further burden the connection or installation process.

Multi-fiber Push On (MPO) is a type of optical connector that is commonly used in high-speed telecom and data communications networks. MPO has been standardized within the IEC 61754-7 and TIA 604-5.

MPO connectors generally include a locking mechanism to maintain connection between the MPO connector and an optical module. Easy-release of the MPO connector from the optical module may be implemented using a pull-to-release mechanism.

Multi-fiber Push On (MPO) connectors are fiber connectors that consist of multiple optical fibers and are available with 8, 12, 16, or 24 fibers for data center and LAN applications (e.g., large scale optical switches require super high-density multi-fiber arrays with MPOs of 32, 48, 60 or even 72 fibers). MPO Connectors must comply with intermateability standards that specify the physical attributes of the connector, such as pin and guide hole dimensions for male and female interfaces, so as to ensure that any compliant plugs and adapters may be intermated and meet a certain level of performance.

MPO Connectors have been used in duplex 10 Gig fiber applications throughout data centers for several years. As the need for bandwidth speeds pushed beyond 10 Gig, the MPO connector became the interface for higher speed switch-to-switch backbone data center applications using parallel optics. For example, 40 Gig and 100 Gig applications over multimode fiber use 8 fibers with 4 transmitting at either 10 Gbps or 25 Gbps and 4 receiving at either 10 Gbps or 25 Gbps. For fiber links to properly send data, the transmit signal (Tx) at one end of the cable must match the corresponding receiver (Rx) at the other end. The purpose of any polarity scheme is to ensure this continuous connection, and this becomes more complex when dealing with multi-fiber components.

Network adapters or top of rack switches become very dense in terms of networking connectors. Therefore, when all the transceivers are plugged in into those networking ports, each having two MPOs, the density of those MPO connectors is so high that it's practically impossible to unplug any individual connector. The whole transceiver should be unplugged and then each individual MPO connector should be unplugged. This is becoming a huge burden that need in real time to debug a very specific optical channel in a very specific system without interrupting the rest of the traffic with the other adjacent MPO connector in the same transceiver. Moreover, the MPO connectors and/or connected positions and/or ports that the MPO connectors are configured to plug into, may, according to industry standards, only support a finite number of connections or connection cycles. For example, the durability of the MPO connectors and/or connected positions/ports may be configured to support 50 or 100 plugging/unplugging cycles. Therefore, accidently unplugging the wrong MPO connector may unnecessarily shorten the usability of the MPO connector and/or the connected position/port from which the MPO connector was unplugged.

Other manufacturers have attempted to address this issue by designing a connector that incorporates a removal solution, but these solutions also suffer from connector density. Additionally, the solution of other manufactures requires the customers to purchase cables from only them. The device for manipulating MPO connectors disclosed herein is designed to be compatible with all types of MPO connectors. Because it uses the cable itself for the lead, it prevents the incorrect removal of a connector or the entire module. Moreover, the heat emitted from switches, transceivers, and/or other components may be sufficient to damage the skin on a person's hand when the person inserts their hand into the cable network to remove an MPO connector. The device for manipulating MPO connectors also prevents/eliminates the need for an operator to insert their hand into the cable network, which is also safer.

In an example embodiment, the MPO manipulation device includes a jacket guide configured for guiding the MPO manipulation device along an optical cable to an MPO connector secured thereto. The optical cable may be any type of networking cable e.g., active optical cables (AOCs), cable assembly with OSFP connectors or the like) or interconnect utilized by datacenter racks and associated switch modules (e.g., a Small Form Pluggable (SFP), quad small form-factor pluggable (QSFP), or the like).

The MPO manipulation device further includes at least one latch portion configured for engaging an MPO connector.

In an example embodiment, the MPO manipulation device may be used to remove an MPO connector from a connected position (e.g., uninstall an MPO connector from a rack and/or the like). In an example embodiment, the MPO manipulation device may be further used to install an MPO connector into a connected position (e.g., install an MPO connector into a rack, and/or the like).

According to one aspect of the present disclosure, an MPO manipulation device is provided. In example embodiment, the MPO manipulation device includes a jacket guide that extends from a first end to a second end along a primary axis of the device. The jacket guide comprises a channel configured for accommodating at least a portion of a cable therein. The MPO manipulation device further includes a first latch portion disposed at the first end of the jacket guide and configured to engage a first MPO connector.

In an example embodiment, the jacket guide has a generally U-shaped cross-section in a plane perpendicular to the primary axis. In an example embodiment, the jacket guide comprises a channel wall that defines the channel. For example, the channel wall may include two extending wall portions that extend from opposite sides of a connecting wall portion. In an example embodiment, an exterior surface of the channel wall is textured and an interior surface of the channel wall is generally smooth.

In an example embodiment, the first latch portion comprises two biased arms. In an example embodiment, biased arm of the two biased arms comprises a ridge configured to engage shoulders of the first MPO connector. In an example embodiment, the ridge comprises a sloped forward-facing surface and a seat surface. In an example embodiment, the seat surface is configured to have the shoulders of the first MPO connector seated there against. In an example embodiment, the seat surface defines an engagement plane that is substantially perpendicular to the primary axis. In an example embodiment, the two biased arms are biased toward one another.

In an example embodiment, the MPO manipulation device further includes a second latch portion disposed at the second end of the jacket guide and configured to engage a second MPO connector. In an example embodiment, the first latch portion is configured to engage the first MPO connector having a first shoulder width and the second latch portion is configured to engage the second MPO connector having a second shoulder width, the first shoulder width being different from the second shoulder width enabling to cover different tolerances of dimensions. In an example embodiment, the first latch portion comprises two first biased arms and the two first biased arms define a first width therebetween, the second latch portion comprises two second biased arms and the second biased arms define a second width therebetween, and the first width is different from the second width.

In an example embodiment, the first latch portion is configured for use in a first configuration to remove the first MPO connector from a connected position and the first latch portion is configured for use in a second configuration to install the first MPO connector into the connected position, wherein the first configuration corresponds to a first rotation angle of the device about the primary axis and the second configuration corresponds to a second rotation angle of the device about the primary axis. In an example embodiment, an angle between the first rotation angle and the second rotation angle is one of 90 degrees or 270 degrees.

According to another aspect of the present disclosure, a method for removing an MPO connector from a connected position is provided. In an example embodiment, the method includes causing at least a portion of a cable secured to the MPO connector to be accommodated within a jacket guide of an MPO manipulation device. The MPO manipulation device includes the jacket guide that extends from a first end to a second end along a primary axis, wherein the jacket guide comprises a channel configured for accommodating that at least a portion of the cable therein, and a latch portion disposed at the first end of the jacket guide and configured to engage the MPO connector. The method further includes sliding the MPO manipulation device along the cable such that the at least a portion of the cable slides through the channel until the latch portion engages the MPO connector; and with the latch portion engaging the MPO connector, pulling the MPO manipulation device away from the connected position, thereby causing the MPO connector to be removed from the connected position.

In an example embodiment, the latch portion comprises two biased arms that are biased toward each other for engaging shoulders of the MPO connector. In an example embodiment, each biased arm of the two biased arms comprises a ridge configured to engage the shoulders of the MPO connector and the ridge comprises a sloped forward-facing surface and a seat surface.

In an example embodiment, sliding the MPO manipulation device along the cable until the latch portion engages the MPO connector causes the shoulders of the MPO to interact with the sloped forward-facing surface of the ridge such that the two biased arms are pushed away from one another due to the interaction of the sloped forward-facing surface of the ridge with the shoulders of the MPO connector, once the sloped forward-facing surface of the ridge has been slide past the shoulders of the MPO connector, biasing of the two biased arms causes the two biased arms to return to an original position such that the seat surface defines a plane substantially parallel to the primary axis. In an example embodiment, pulling the MPO manipulation device away from the connected position with the portion engaging the MPO connector causes the seat surface to engage and impart a force on the shoulders of the MPO connector such that the MPO connector is removed from the connected position.

According to another aspect of the present disclosure, a method for installing an MPO connector into a connected position is provided. In an example embodiment, the method comprises causing engagement of an MPO connector with an MPO manipulation device. The MPO manipulation device includes a jacket guide that extends from a first end to a second end along a primary axis, wherein the jacket guide comprises a channel configured for accommodating that at least a portion of the cable therein, and a latch portion disposed at the first end of the jacket guide and configured to engage the MPO connector. The method further includes inserting the MPO connector into the connected position using the MPO manipulation device; and releasing the MPO connector from engagement with the MPO manipulation device.

### BRIEF DESCRIPTION OF THE SEVERAL VIEWS OF THE DRAWINGS

Reference will now be made to the accompanying drawings, which are not necessarily drawn to scale, and wherein:

FIG. 1 provides a top schematic view of an example MPO manipulation device, in accordance with certain embodiments;

FIG. 1A provides a cross-sectional view of an example MPO manipulation device taken along the line AA shown in FIG. 1, in accordance with certain embodiments;

FIG. 2 provides a perspective view of an MPO manipulation device engaging an MPO connector in a connected position, in accordance with certain embodiments;

FIG. 3 provides a top view of a latch portion of an MPO manipulation device engaging an MPO connector, in accordance with certain embodiments;

FIG. 3A schematically illustrates the angular relationship between the seat surface of an example latch portion and the primary axis of the MPO manipulation device, in accordance with certain embodiments;

FIGS. 4 and 5 provide respective views of an example MPO connector engaging an MPO connector in a connected position in a high-density environment, in accordance with certain embodiments;

FIG. 6A provides an end view of an example MPO manipulation device engaging an MPO connector in a first configuration, in accordance with certain embodiments;

FIG. 6B provides an end view of an example MPO manipulation device engaging an MPO connector in a second configuration, in accordance with certain embodiments;

FIG. 6C provides a comparison of the first configuration and the second configuration, in accordance with certain embodiments;

FIG. 6D provides a zoomed in view of an example biased arm of a latch portion of an MPO manipulation device, in accordance with certain embodiments;

FIG. 7 provides a flowchart illustrating processes, procedures, and/or operations for removing an MPO connector from a connected position using an MPO manipulation device, in accordance with certain embodiments;

FIG. 7A provides a perspective view of an MPO manipulation device engaging an MPO connector to extract the MPO connector from a connected position;

FIG. 8 provides a flowchart illustrating processes, procedures, and/or operations for installing an MPO connector into a connected position using an MPO manipulation device, in accordance with certain embodiments;

FIG. 8A provides a perspective view of an MPO manipulation device engaging an MPO connector to insert or install the MPO connector into a connected position; and

FIG. 9 provides a block diagram of one example environment that may have a high density of MPO connectors and in which an MPO manipulation device may be useful for extracting MPO connectors from connected positions and/or installing MPO connectors into connected positions.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

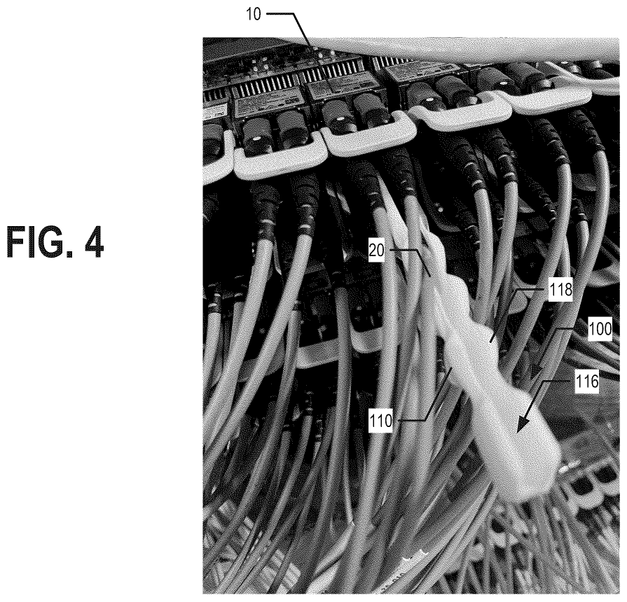

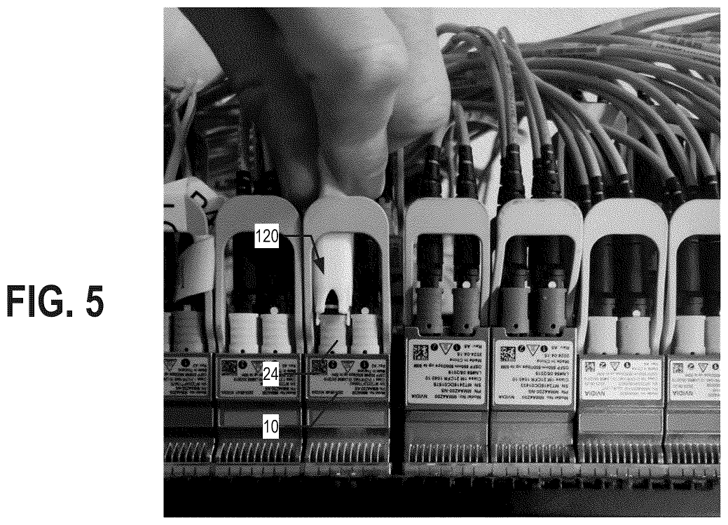

Various embodiments provide an MPO manipulation device that may be used to install an MPO connector into a connected position and/or remove an MPO connector from a connected position. MPO connectors are generally used to connect optical cables including an array of optical fibers to optical transmitters, receivers, and/or transceivers. For example, in datacenters, optical cables may be used to link various components, including different server racks. The optical cables may have MPO connectors secured to the ends thereof. As shown in FIGS. 4 and 5, the MPO connectors are often installed into connected positions in high-density environments in which components such as transceivers are placed one on the top of the others. For example, a rack may be configured and/or designed to have a plurality of MPO connectors connected thereto with very little space in between the individual MPO connectors.

While this provides an efficient use of space, the high density of MPOs can make it difficult to install or remove MPOs into/from connected positions in the rack. For example, it may be desired to extract a particular MPO in order to debug a particular optical channel. However, it may be desired to leave MPOs installed in neighboring connected positions in place such that communication along those optical channels is not interrupted. Identifying the particular MPO to remove and then getting one's fingers into position to extract the particular MPO can be difficult. Similarly, reaching into a high-density installation of MPOs to install an MPO into connected position can also be difficult given the small space provided for performing such a task. Therefore, technical problems exist regarding the manipulation of MPOs into and/or out of connected positions.

Various embodiments provide technical solutions to these technical challenges. For example, various embodiments provide an MPO manipulation devices and methods for using an MPO manipulation device to remove or extract an MPO from a connected position and/or to install an MPO into a connected position. In certain embodiments, an MPO manipulation device includes a jacket guide. The jacket guide includes a channel therein configured for accommodating at least a portion of a cable therein (e.g., an optical cable having an MPO secured to an end thereof). A distance away from the rack where there is more room to perform manipulations, the MPO manipulation device may be slid onto the cable. With a portion of a cable corresponding to the MPO connector to be removed accommodated and/or disposed within the channel of the jacket guide, the jacket guide may be slid along the cable until a latch portion of the MPO manipulation device engages the MPO secured to the end of the cable. Once the MPO manipulation device engages the MPO, pulling the MPO manipulation device away from the connected position causes the MPO to be removed or extracted from the connected position.

For example, the MPO manipulation device includes a latch portion configured for engaging an MPO connector and a jacket guide that enables the MPO manipulation device to be slide along a cable having the MPO connector secured to an end thereof such that manipulations to identify the MPO connector may be performed at a distance from the rack where there is sufficient space to perform such manipulations without affecting the optical connections of other optical channels and/or MPO connectors. Additionally the jacket guide enables one to manipulate the position of an MPO connector and/or to assert a force on an MPO connector that is engaged with the latch portion of the MPO manipulation tool from a distance. Thus, one does not need to reach their fingers into the area directly adjacent to the rack which may be densely populated with other MPO connectors.

Thus, various embodiments provide technical solutions to technical challenges regarding the manipulation of MPO connectors into and/or out of connected positions.

### Example MPO Manipulation Device

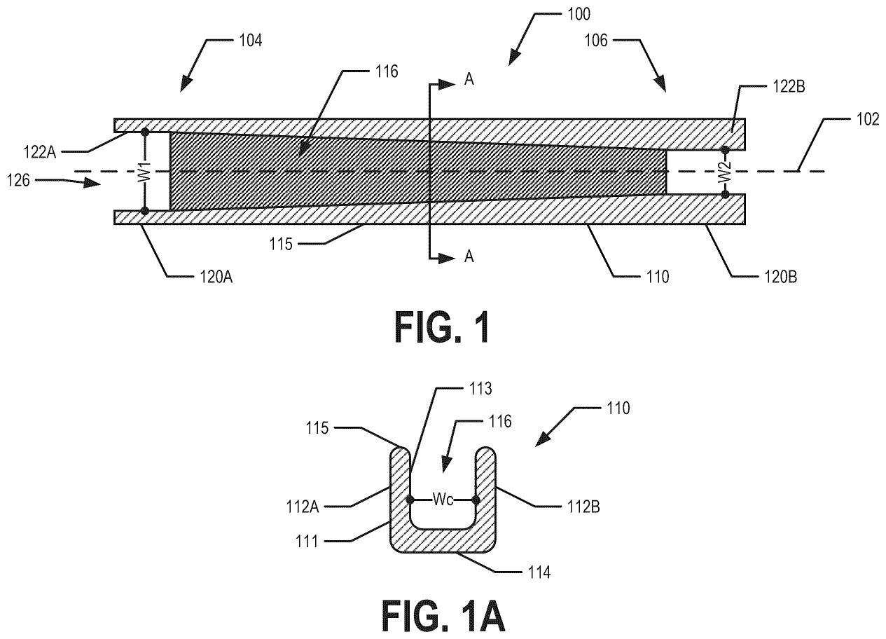

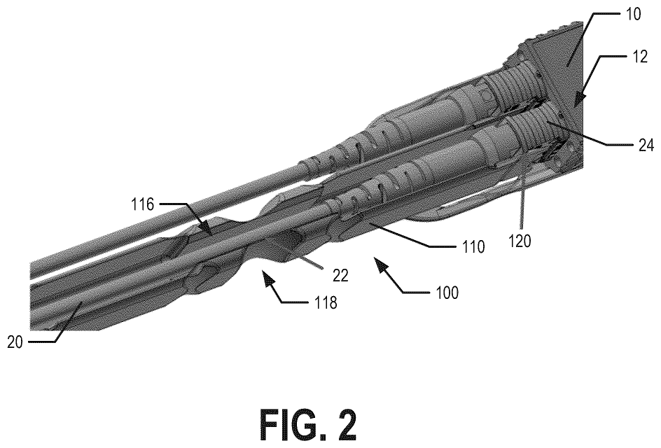

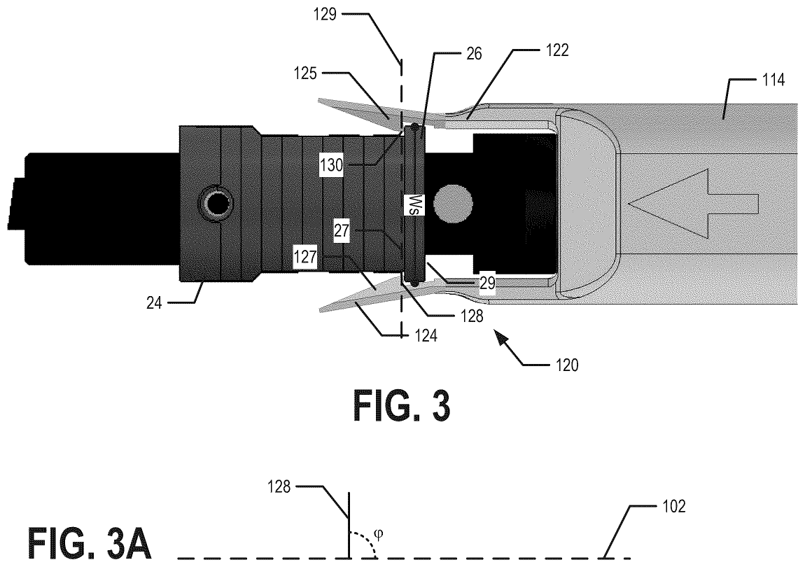

FIG. 1 illustrates a schematic top view of an example MPO manipulation device 100 according to an example embodiment and FIG. 1A provides a cross-sectional view of the example MPO manipulation device 100 taken at line AA of FIG. 1. For example, the cross-sectional view shown in FIG. 1A is taken in a plane that is perpendicular to the primary axis 102 of the MPO manipulation device 100. FIG. 2 provides a perspective view of an MPO manipulation device 100 engaging an MPO connector 24 which is in a connected position 12 defined and/or provided by a transceiver 10. For example, a transceiver 10 may include connected positions 12 that are sockets and/or MPO connector receivers configured to receive and/or mechanically and optically couple to MPO connectors. FIG. 3 illustrates a latch portion 120 of an MPO manipulation device 100 engaging an MPO connector 24 in a first configuration. FIGS. 4 and 5 show an MPO manipulation device 100 engaging an MPO connector 24 in high density environments.

In various embodiments, an MPO manipulation device 100 includes a jacket guide 110 that extends along the primary axis 102 of the MPO manipulation device 100 from a first end 104 to a second end 106. A first latch portion 120A is disposed at the first end 104 of the jacket guide 110. In certain embodiments, a second latch portion 120B is disposed at the second end 106 of the jacket guide 110. However, some embodiments only include a single latch portion 120 disposed at an end of the jacket guide 110.

In various embodiments, the jacket guide 110 comprises a channel wall 115 and a channel 116. In the illustrated embodiment, the channel wall 115 includes first extending wall portion 112A, second extending wall portion 112B, and connecting wall portion 114. The first extending wall portion 112A and the second extending wall portion 112B extend in a same direction from opposite sides or ends of the connecting wall portion 114. The channel 116 is an open space or volume defined by the first extending wall portion 112A, the second extending wall portion 112B, and the connecting wall portion 114.

In various embodiments, the channel 116 has a width of a channel width Wc in a direction that is substantially perpendicular to the primary axis 102 and substantially parallel to the connecting wall portion 114. In various embodiments, the channel width Wc is configured such that an optical cable 20 may be accommodated, at least in part, within the channel 116. For example, the channel width Wc may be at least as large as the diameter of a multi-fiber optical cable 20. For example, the cable 20 may include a plurality of optical fibers within a jacket 22. In certain embodiments, the channel width Wc is in a range of 5 to 50 mm.

In certain embodiments, the first and second extending wall portions 112A, 112B may extend out substantially normal and/or perpendicular to the connecting wall portion 114. For example, the width of the channel 116 may be constant along a depth of the channel 116. In certain embodiments, the first and second extending wall portions 112A, 112B extend outward from the connecting wall portion such that they angle toward one another. In other words, the width of the channel may not be constant along a depth of the channel 116. For example, a width of the channel 116 may be larger closer to the connecting wall portion 114 compared to closer to the free ends of the extending wall portions 112A, 112B. This may act to assist in holding the cable 20 within the channel 116 as the MPO manipulation device 100 is slide along the cable 20 with the cable at least partially accommodated and/or disposed within the channel 116.

The channel wall 115 includes an interior surface 113 and an exterior surface 111. In an example embodiment, the exterior surface 111 includes texture 118 configured to assist one in gripping the jacket guide with one's hand. In an example embodiment, the interior surface 113 is substantially smooth (e.g., lacking texture) such that a cable may slide smoothly through the channel 116 of the jacket guide 110.

In various embodiments, a latch portion 120 includes two biased arms 122 or a pair of biased arms. An engagement opening 126 is defined between the two biased arms 122. The biased arms 122 of a pair of biased arms may be biased toward one another so as to engage an MPO connector 24 therebetween. For example, the biased arms 122 may be configured such that, after a biased arm 122 is flexed outward or away from the other biased arm 122 of the pair of biased arms, the biased arm 122 experiences a restoring force configured to return the biased arm back to its original position (e.g., its position prior to being flexed outward and/or away from the other biased arm of the pair of biased arms).

In various embodiments, the biasing of the arms is provided by the material of the MPO manipulation device 100. For example, in certain embodiments, the MPO manipulation device 100 is formed of and/or comprises a resilient material. For example, the MPO manipulation device 100 may be formed of and/or comprise a polymeric material (e.g., plastic injected).

In various embodiments, a distance between a pair of biased arms 122 in a non-engaged position is approximately equal to slightly less than the shoulder width Ws of the shoulder of the MPO connector 24. In some embodiments, the pair of biased arms 122 is configured to engage a flange or shoulder 26 (referred to as the shoulder herein) of an MPO connector 24 via a friction fit or an interference fit.

In various embodiments, each biased arm 122 includes an arm portion 124 and a ridge 125 that extends out from the arm portion 124 and toward the other biased arm 122 of the pair of biased arms. In various embodiments, the ridge 125 is configured to engage a shoulder 26 of the MPO connector 24. For example, a ridge 125 may extend outward from the arm portion 124 of a biased arm 122 so as to provide a seat surface 128 for engaging the shoulder 26 of an MPO connector 24. For example, the ridge 125 may be configured such that, once the shoulder 26 of the MPO connector 24 is slid past the ridge 125, the ridge 125 acts to retain the shoulder 26 of the MPO connector 24 confined and/or engaged within the latch portion 120 with respect to movement along of the MPO manipulation device 100 where the primary axis 102 is substantially parallel to the optical cable 20 (locally). For example, in various embodiments, the ridge 125 extends outward from arm portion 124 so as to provide a constriction within the engagement opening 126.

In various embodiments, the ridge 125 is configured such that the shoulder 26 of the MPO connector 24 is able to pass by the ridge 125 as the MPO manipulation device 100 is slide along the cable 20, but once the ridge 125 passes the shoulder 26 of the MPO connector 24, the ridge 125 prevents the shoulder 26 from moving away from the MPO manipulation device 100 along the primary axis 102 of the MPO manipulation device 100.

For example, in the illustrated embodiment, the ridge 125 includes the sloped forward-facing surface 127 and a seat surface 128 which meet or are joined/connected together at the inflection line 130. As schematically illustrated in FIG. 3A, the seat surface 128 forms an angle q with respect to the primary axis 102 of the MPO manipulation device 100. In various embodiments, the angle q is 90 degrees or less (e.g., 0<φ≤90 degrees). In certain embodiments, the angle q is in a range of 60 degrees to 90 degrees (e.g., 60≤φ≤90 degrees).

The seat surfaces 128 of a pair of biased arms 122 define a seat plane 129 that is substantially perpendicular to the primary axis 102. For example, the seat surfaces 128 are configured such that the shoulder 26 of the MPO connector 24 becomes seated against the seat surface 128 when the MPO manipulation device 100 is pulled or moved, substantially along the primary axis 102, away from the connected position 12 at which the MPO connector 24 is installed. For example, the seat surfaces 128 are configured to impart a force onto the shoulder 26 of an MPO connector 24 engaged by the latch portion 120 that is sufficient to disengage, remove, or extract the MPO connector 24 from the connected position 12.

In the example embodiment shown in FIG. 4, the MPO manipulation device 100 includes only one latch portion, which is engaged with an MPO connector installed in a rack. In the example embodiment shown in FIG. 1, the MPO manipulation device 100 includes a first latch portion 120A and a second latch portion 120B. The first latch portion 120A includes a first pair of biased arms 122A and the second latch portion 120B includes a second pair of biased arms 122B. The distance between the first pair of biased arms 122A is a first width W1 and the distance between the second pair of biased arms 122B is a second width W2. In various embodiments, the first width W1 is different from the second width W2 (e.g., W1≠W2). For example, the first latch portion 120A may be configured for use with MPO connectors 24 of a first size and the second latch portion 120B may be configured for use with MPO connectors 24 of a second size.

In various embodiments, the MPO manipulation device 100 is configured for use in installing an MPO connector 24 at a connected position 12 and for removing or extracting an MPO connector 24 from a connected position 12. In some embodiments, the MPO manipulation device 100 is configured for use in a first configuration to remove an MPO connector 24 from a connected position 12 and the MPO manipulation device 100 is configured for use in a second configuration to install the MPO connector 24 into the connected position 12. For example, in the first configuration, the latch portion 120 is configured to engage the plug-facing surface 27 of the shoulder 26 of the MPO connector 24 and to impart a force thereon (e.g., to pull the MPO connector out of the connected position 12). In the second configuration the latch portion 120 is configured to engage the cable-facing surface 29 of the should 26 of the MPO connector 24 and to impart a force thereon (e.g., to push the MPO connector into the connected position 12).

In an example embodiment, a first latch portion 120A disposed on a first end 104 of the jacket guide 110 is configured for removing or extracting an MPO connector 24 from a connected position 12 and a second latch portion 120B disposed on a second end 106 of the jacket guide 110 is configured for installing an MPO connector 24 in a connected position 12. In certain embodiments, a latch portion 120 is configured for both installing and removing/extracting an MPO connector 24 in/from a connected position 12.

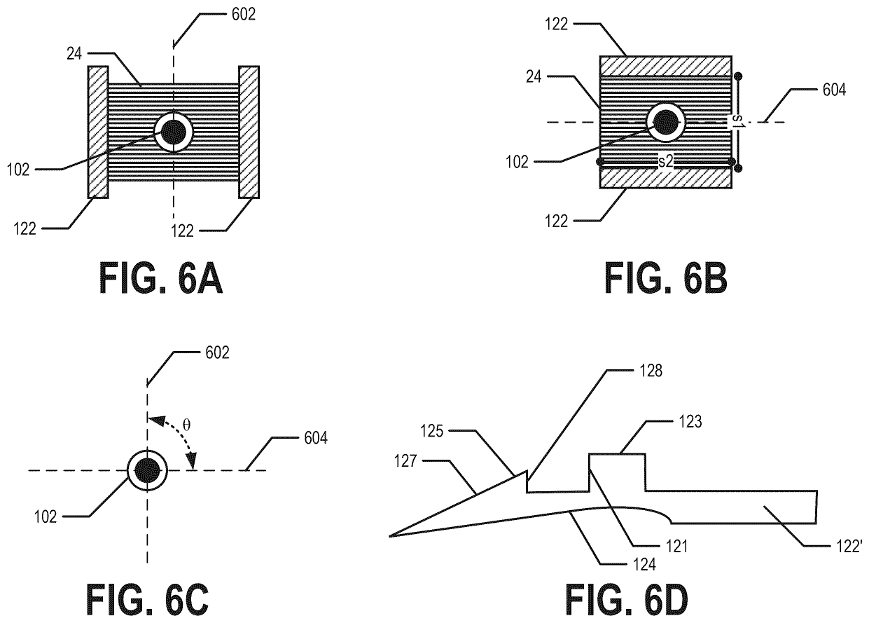

For example, FIG. 6A provides an end view of a pair of biased arms 122 engaging an MPO connector 24 in a first configuration. The first configuration corresponds to a first rotation angle of the MPO manipulation device 100 about the primary axis 102. For example, the first plane 602 illustrating the first rotation angle includes the primary axis 102 and is parallel to the biased arms 122 of the latch portion 120.

FIG. 6B provides an end view of a pair of biased arms 122 engaging an MPO connector 24 in a second configuration. The second configuration corresponds to a second rotation angle of the MPO manipulation device 100 about the primary axis 102. For example, the second plane 604 illustrating the first rotation angle includes the primary axis 102 and is parallel to the biased arms 122 of the latch portion 120.

FIG. 6C illustrates the relationship between the first plane 602 illustrating the first rotation angle corresponding to the first configuration and the second plane 604 illustrating the second rotation angle corresponding to the second configuration. For example, the first configuration corresponds to a first rotation angle of the device about the primary axis and the second configuration corresponds to a second rotation angle of the device about the primary axis. In certain embodiments, the angle θ between the first rotation angle and the second rotation angle is one of 90 degrees or 270 degrees.

FIG. 6D illustrates an example biased arm 122′ that includes an arm portion 124, a ridge 125 having a sloped forward-facing surface 125 and a seat surface 128, and a raised rim 123 comprising a rim surface 121. The raised rim 123 extends further from the arm portion 124 and the ridge 125. As shown in FIGS. 6A and 6B, the MPO connector 24 may have a first width s1 in a first dimension in a plane perpendicular to the primary axis 102 when the MPO connector 24 is engaged by the latch portion 120 and a second width s2 in a second dimension in the plane perpendicular to the primary axis 102 when the MPO connector 24 is engaged by the latch portion 120. The first width s1 is different from the second distance s2. For example, in the plane perpendicular to the primary axis 102 when the MPO connector 24 is engaged by the latch portion 120, the MPO connector 24 may be rectangular (and not a square). The difference between the first width s1 and the second width s2 of the MPO connector 24 enable the change in the interaction between the biased arms 122′ and the MPO connector 24. For example, the narrower of the first width and the second width may be less than or approximately equal to the distance between the inflection lines 123 of the pair of biased arms 122′ when the biased arms 122′ are in an original position (e.g., the position they were in prior to interacting with the shoulder 26 of the MPO connector 24). The wider of the first width and the second width may be greater than the distance between the inflection lines 123 of the pair of biased arms 122′ when the biased arms 122′ are in an original position (e.g., the position they were in prior to interacting with the shoulder 26 of the MPO connector 24).

The different widths of the MPO connector 24 may enable the rotation of the MPO manipulation device 100 about the primary axis 102 by the angle θ to switch between the first configuration and the second configuration. For example, in the first configuration the biased arms 122′ engage the MPO connector 24 such that the seat surface 128 is configured to impart a (pull) force to the MPO connector 24 and in the second configuration the biased arms 122′ engage the MPO connector such that the rim surface 121 imparts a (push) force to the MPO connector 24.

Example Method of Using an MPO Manipulation Device to Remove an MPO Connector from a Connected Position

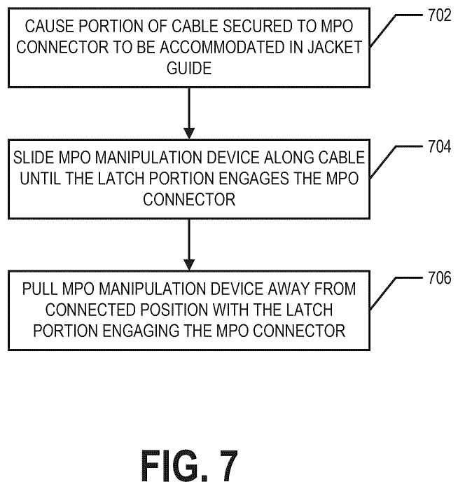

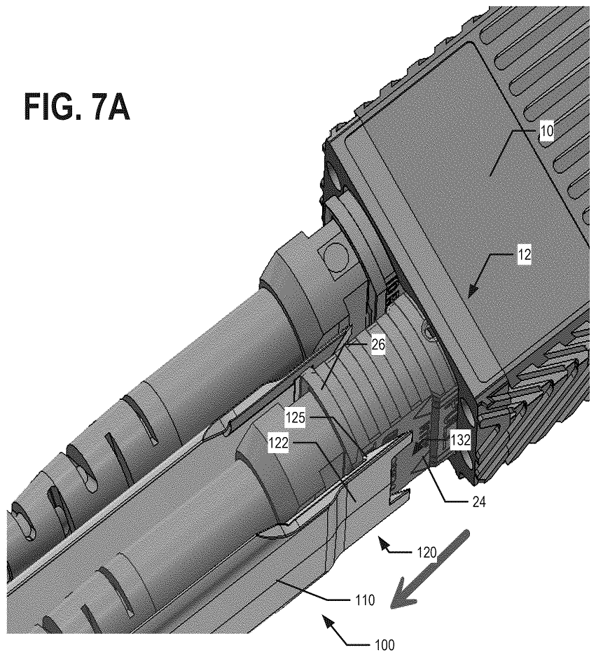

FIG. 7 provides a flowchart illustrating various processes, procedures, operations, and/or the like of using an MPO manipulation device 100 to remove or extract and MPO connector from a connected position. For example, the connected position may be a connected position 12 defined and/or provided by a transceiver 10 that may be installed in a rack, possibly along with numerous other transceivers.

Starting at step 702, a user causes a portion of a cable 20 having an MPO connector 24 secured to an end thereof to be accommodated and/or disposed within the jacket guide 110. For example, a user may place a portion of the cable 20 within the channel 116 of the jacket guide 110.

At step 704, the user slides the MPO manipulation device 100 along the cable 20 until the latch portion 120 engages the MPO connector 24. For example, while the cable 20 is maintained, in part, within the channel 116, the MPO manipulation device 100 is moved or slide along a portion of the length of the cable 20 such that the latch portion 120 moves toward the MPO connector to be removed or extracted from the connected position 12. For example, the MPO manipulation device 100 is slid along the cable 20 such that the primary axis 102 of the MPO manipulation device 100 is parallel to at least a portion of the cable (e.g., the portion of the cable accommodated and/or disposed within the channel 116). The pair of biased arms 122 of the latch portion 120 slide over the shoulder 26 of the MPO connector 24 until the pair of biased arms 122 engages the shoulder 26 of the MPO connector 24.

In certain embodiments, the ridges 125 of the pair of biased arms 122 may engage the shoulder 26 of the MPO connector 24. For example, the sloped forward-facing surfaces 127 of the biased arms may interact with the shoulder 26 of the MPO connector 24 and cause the biased arms 122 to flex outward (e.g., away from one another) as the MPO manipulation device 100 is slide along the cable 20. Once the sloped forward-facing surfaces 127 have slid passed the shoulder 26 of the MPO connector 24, the biasing of the biased arms 122 toward one another causes the biased arms 122 to unflex such that the seat surfaces 128 of the biased arms 122 are positioned to prevent the shoulder 26 of the MPO connector 24 from disengaging with the latch portion 120 of the MPO manipulation device 100.

For example, sliding the MPO manipulation device 100 along the cable 20 until the latch portion 120 engages the MPO connector 24 causes the shoulder 26 of the MPO connector 24 to interact with the sloped forward-facing surface 127 of the ridge 125 such that the two biased arms 122 are pushed away from one another due to the interaction of the sloped forward-facing surface 127 of the ridge 125 with the shoulder 26 of the MPO connector 24. Once the sloped forward-facing surface 127 of the ridge 125 has been slid past the shoulder 26 of the MPO connector 24, the biasing of the two biased arms 122 causes the two biased arms 122 to return to (approximately) an original position (e.g., the position they were in prior to interacting with the shoulder 26 of the MPO connector 24) such that the seat surface 128 defines a seat plane 129 that is substantially parallel to the primary axis 102.

In various embodiments, the MPO manipulation device 100 is configured to provide a user with audible and/or haptic feedback when the inflection lines 130 of the ridges 125 have been slid past the shoulder 26 of the MPO connector 24. In some embodiments, a user may feel (e.g., via a hand that is holding the MPO manipulation device 100) and/or hear the biased arms 122 unflexing and/or snapping back such that a user is provided with haptic and/or audible feedback that the MPO connector 24 has been engaged by the latch portion 120 of the MPO manipulation device 100.

While the MPO connector 24 is engaged by the latch portion 120 of the MPO manipulation device 100, the user may pull the MPO manipulation device away from the connected position 12, at step 706, to cause the MPO connector 24 to be removed and/or extracted from the connected position 12. For example, when the MPO connector 24 is engaged by the latch portion 120, the primary axis 102 of the MPO manipulation device 100 may be generally aligned and/or parallel to a connected position axis defined by the connected position. The MPO manipulation device 100 may be pulled away from the connected position 12 in a direction generally aligned and/or parallel to the connected position axis and/or the primary axis 102 of the MPO manipulation device 100, as shown in FIG. 7A. For example, FIG. 7A illustrates an MPO manipulation device 100 being used in a first configuration to extract an MPO connector 24 from a connected position 12 by engaging the shoulder 26 of the MPO connector 24 with the latch portion 120 (e.g., via ridges 125) of the MPO manipulation device 100.

As the MPO manipulation device 100 is pulled away from the connected position 12, the shoulder 26 of the MPO connector 24 is seated against the seat surface 128 of the ridge 125. As a result, the seat surface 128 imparts a force to the shoulder 26 of the MPO connector 24 in the direction in which the MPO manipulation device 100 is being pulled. In various embodiments, the biased arms 122 are configured such that the seat surface 128 imparts a sufficient force to the shoulder 26 of the MPO connector 24 as to cause the MPO connector 24 to be removed or extracted from the connected position 12.

Once the MPO connector 24 is moved sufficiently far enough away from the connected position 12 to enable sufficient space for such a manipulation, the user may then slide the MPO connector 24 out the engagement with the latch portion 120 (e.g., in a direction transverse to the primary axis 102) or may apply a small force to cause the biased arms 122 to flex away from one another to release the MPO connector 24 from engagement with the latch portion 120.

Example Method of Using an MPO Manipulation Device to Install an MPO Connector into a Connected Position

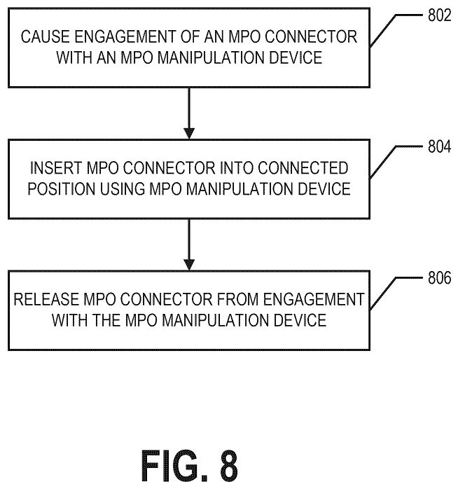

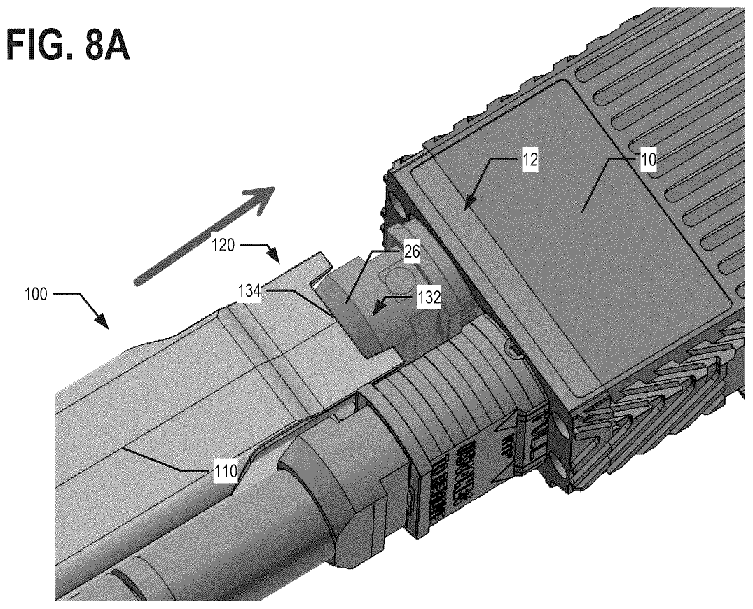

FIG. 8 provides a flowchart illustrating various processes, procedures, operations, and/or the like of using an MPO manipulation device 100 to install and MPO connector 24 into a connected position. For example, the connected position may be a connected position 12 defined and/or provided by a transceiver 10 that may be installed in a rack, possibly along with numerous other transceivers.

Starting at step 802, a user causes engagement of the MPO connector with an MPO manipulation device 100. For example, a user may cause a portion of a cable 20 having an MPO connector 24 secured to an end thereof to be accommodated and/or disposed within the jacket guide 110. For example, a user may place a portion of the cable 20 within the channel 116 of the jacket guide 110. The user may slide the MPO manipulation device 100 along the cable 20 to cause the latch portion 120 to slide onto the MPO connector 24. The MPO manipulation device 100 is slid along the cable 20 until the shoulder 26 of the MPO connector 24 is engaged by the latch portion 120. For example, the shoulder 26 may be disposed between the seat surface 128 and the rim surface 121.

FIG. 8A illustrates another example embodiment of an MPO manipulation device 100 configured for both extraction of MPO connectors 24 from connected positions 12 (e.g., when used in a first configuration as shown in FIG. 7A) and insertion and/or installation of MPO connectors 24 into connected positions 12 when used in a second configuration (e.g., as shown in FIG. 8A). When the MPO manipulation device 100 is rotated 90 degrees (or 270 degrees) from the first configuration shown in FIG. 7A, the MPO manipulation device 100 is in a second configuration that is configured for insertion/installation of an MPO connector 24 into a connected position 12. For example, rather than the shoulder 26 of the MPO connector being seated against the seat surfaces 128 of the MPO manipulation device 100 as used to perform the extraction of the MPO connector, when the MPO manipulation device 100 engages an MPO connector 24 for insertion/installation (e.g., in the second configuration), the shoulder 26 of the MPO connector 24 is engaged by an installation surface 134 that connects a pair of biased arms 122 and is partially defined by opening 132. In the second configuration, the ridge 125 does not engage the shoulders 26 of the MPO connector.

Continuing with FIG. 8, at step 804, the user inserts the MPO connector 24 into the connected position 12 using the MPO manipulation device 100, as illustrated by the arrow in FIG. 8A. For example, the user aligns the MPO connector 24 with the connected position 12 while using the MPO manipulation device 100 as a handle for the MPO connector 24. Once, the MPO connector 24 is aligned with the MPO manipulation device 100, the user may move the MPO manipulation device 100 toward the connected position 12 (substantially along the primary axis 102). The rim surface 121 may impart a force to the shoulder 26 of the MPO connector 24 causing the MPO connector to mate with and/or be pushed into the connected position 12.

At step 806, the user may release the MPO connector 24 from engagement with the MPO manipulation device 100. For example, the MPO connector 24 may be released from engagement with the MPO manipulation device 100 by moving the MPO manipulation device away from the connected position substantially along the primary axis 102. For example, because the shoulders 26 of the MPO connector 24 are not engaged by the ridges 125, the MPO manipulation device 100 may be moved away from the connected position 12 (e.g., substantially along the primary axis 102) to disengage the MPO connector 24 from the latch portion 120. In certain embodiments, the MPO connector 24 may be released from engagement with the MPO manipulation device 100 by rotating the MPO manipulation device 100 while moving the MPO manipulation device away from the connected position substantially along the primary axis 102, and/or the like. The MPO connector 24 is retained in the connected position.

### Example System Use-Case

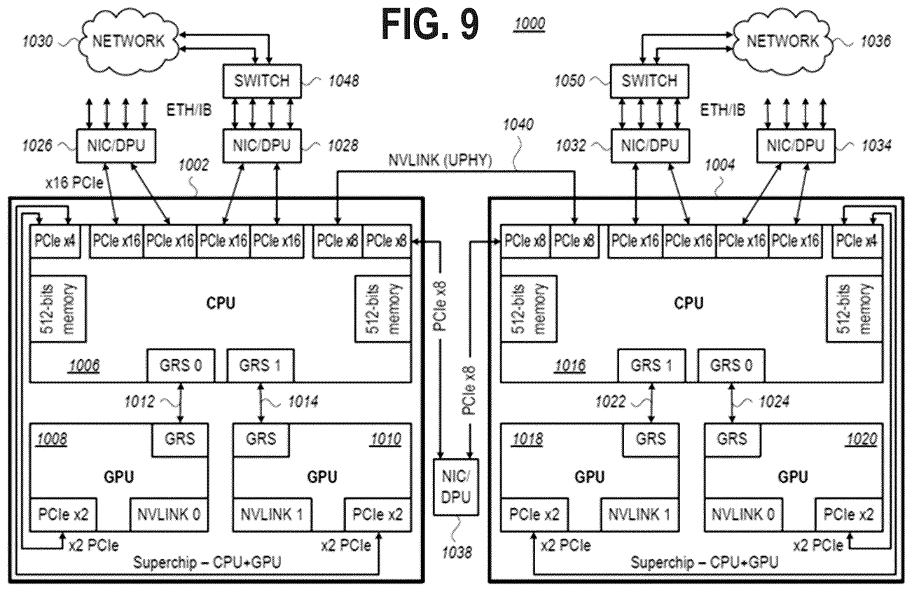

FIG. 9 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a network interface card (NIC) or data processing unit (DPU) to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more NICs or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 9 also demonstrates an example architecture of a multi-GPU architecture. As illustrated in FIG. 9, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 9, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 3, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects. The packet switches in FIG. 9 may comprise, for example, Nvidia Quantum-2 switches. The NICs/DPUs in the figure may comprise, for example, Nvidia Bluefield DPUs.

In certain scenarios, various components of the system 1000 may be in communication with various other components of the system 1000 via optical cables that are installed into connected positions via MPO connectors. For example, high-bandwidth communication interconnects 1040 and/or various other interconnects may be implemented via one or more optical cables. The MPO connectors that place the optical cables into optical communication with the various components of the system 1000 may be installed into a high-density environment such that very little room is available for a user (e.g., a technician) to reach their fingers into the MPO connector proximate the connected position. Thus, an MPO manipulation device 100 may be used to install MPO connectors into connected positions of the system 1000 and/or to extract MPO connectors from connected positions of the system 1000.

FIG. 9 is provided to illustrate one example system with which an MPO manipulation device 100 may be used. As should be understood, MPO manipulation devices 100 may be used to install MPO connectors into and/or to extract MPO connectors from connected positions of a variety of systems using optical cables to couple various components into optical communication with one another.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A device for manipulating multi-fiber push on (MPO) connectors, the device comprising:
a jacket guide that extends from a first end to a second end along a primary axis, wherein the jacket guide comprises a channel configured for accommodating at least a portion of a cable therein; and
a first latch portion disposed at the first end of the jacket guide and configured to engage a first MPO connector.

2. The device of claim 1, wherein the jacket guide has a generally U-shaped cross-section in a plane perpendicular to the primary axis.

3. The device of claim 1, wherein the jacket guide comprises a channel wall that defines the channel.

4. The device of claim 3, wherein an exterior surface of the channel wall is textured and an interior surface of the channel wall is generally smooth.

5. The device of claim 1, wherein the first latch portion comprises two biased arms that are biased toward one another.

6. The device of claim 5, wherein each biased arm of the two biased arms comprises a ridge configured to engage shoulders of the first MPO connector.

7. The device of claim 6, wherein the ridge comprises a sloped forward-facing surface and a seat surface.

8. The device of claim 7, wherein the seat surface is configured to engage the shoulders of the first MPO connector.

9. The device of claim 7, wherein the seat surface defines an engagement plane that is substantially perpendicular to the primary axis.

10. The device of claim 1, further comprising a second latch portion disposed at the second end of the jacket guide and configured to engage a second MPO connector.

11. The device of claim 10, wherein the first latch portion is configured to engage the first MPO connector having a first shoulder width and the second latch portion is configured to engage the second MPO connector having a second shoulder width, the first shoulder width being different from the second shoulder width.

12. The device of claim 10, wherein the first latch portion comprises two first biased arms and the two first biased arms define a first width therebetween, the second latch portion comprises two second biased arms and the two second biased arms define a second width therebetween, and the first width is different from the second width.

13. The device of claim 1, wherein the first latch portion is configured for use in a first configuration to remove the first MPO connector from a connected position and the first latch portion is configured for use in a second configuration to install the first MPO connector into the connected position, wherein the first configuration corresponds to a first rotation angle of the device about the primary axis and the second configuration corresponds to a second rotation angle of the device about the primary axis.

14. The device of claim 13, wherein an angle between the first rotation angle and the second rotation angle is one of 90 degrees or 270 degrees.

15. A method for removing an MPO connector from a connected position, the method comprising:
causing at least a portion of a cable secured to the MPO connector to be accommodated within a jacket guide of an MPO manipulation device, wherein the MPO manipulation device comprises:
the jacket guide that extends from a first end to a second end along a primary axis, wherein the jacket guide comprises a channel configured for accommodating that the at least a portion of the cable therein, and
a latch portion disposed at the first end of the jacket guide and configured to engage the MPO connector;
sliding the MPO manipulation device along the cable such that the at least a portion of the cable slides through the channel until the latch portion engages the MPO connector; and
with the latch portion engaging the MPO connector, pulling the MPO manipulation device away from the connected position, thereby causing the MPO connector to be removed from the connected position.

16. The method of claim 15, wherein the latch portion comprises two biased arms that are biased toward each other for engaging shoulders of the MPO connector.

17. The method of claim 16, wherein each biased arm of the two biased arms comprises a ridge configured to engage the shoulders of the MPO connector and the ridge comprises a sloped forward-facing surface and a seat surface.

18. The method of claim 17, wherein sliding the MPO manipulation device along the cable until the latch portion engages the MPO connector causes the shoulders of the MPO connector to interact with the sloped forward-facing surface of the ridge such that the two biased arms are pushed away from one another due to interaction of the sloped forward-facing surface of the ridge with the shoulders of the MPO connector, once the sloped forward-facing surface of the ridge has been slid past the shoulders of the MPO connector, biasing of the two biased arms causes the two biased arms to return to an original position such that the seat surface defines a seat plane that is substantially parallel to the primary axis.

19. The method of claim 18, wherein pulling the MPO manipulation device away from the connected position with the portion engaging the MPO connector causes the seat surface to impart a force on the shoulders of the MPO connector such that the MPO connector is removed from the connected position.

20. A method for installing an MPO connector into a connected position, the method comprising:
causing engagement of the MPO connector secured to an end of an optical cable with an MPO manipulation device, wherein the MPO manipulation device comprises:
a jacket guide that extends from a first end to a second end along a primary axis, wherein the jacket guide comprises a channel configured for accommodating that at least a portion of the optical cable therein, and
a latch portion disposed at the first end of the jacket guide and configured to engage the MPO connector;
inserting the MPO connector into the connected position using the MPO manipulation device; and
releasing the MPO connector from the engagement with the MPO manipulation device.
